(19) United States
(12) Patent Application Publication
(10) Pub. No.: US 2016/0086202 A1
(43) Pub. Date: Mar. 24, 2016

(54) METHOD AND ELECTRONIC DEVICE FOR RATING OUTFIT

(71) Applicant: National Tsing Hua University, Hsinchu City (TW)

(72) Inventors: Shan-Hung Wu, Hsinchu (TW); Cheng-Yu Hsu, Hsinchu County (TW); You-Jhih Wong, Keelung City (TW)

(21) Appl. No.: 14/601,256

(22) Filed: Jan. 21, 2015

(30) Foreign Application Priority Data
Sep. 24, 2014 (TW) 103133008

(51) Int. Cl. G06Q 30/02; G06Q 50/00; G06Q 30/06

(52) U.S. Cl. CPC G06Q 30/0203; G06Q 30/0201; G06Q 30/0629; G06Q 50/01

(57) ABSTRACT

A method and an electronic device for rating outfit are provided. In the method, a plurality of candidate items are received, and each two of the candidate items are paired to create a plurality of questions, where each of the questions includes two candidate items among the candidate items. The questions are respectively transmitted to a plurality of raters in a group, and a selection of each of the raters on the two candidate items in the received question is received. A number of times that each of the candidate items is selected is aggregated, and accordingly the candidate items are sorted to form a recommending series. In addition, a rating for at least one of the candidate items is received, and the raters who selected the candidate item matching the rating are searched to serve as the raters for a subsequent outfit rating.

### CROSS-REFERENCE TO RELATED APPLICATION

This application claims the priority benefit of Taiwan application serial no. 103133008, filed on Sep. 4, 2014. The entirety of the above-mentioned patent application is hereby incorporated by reference herein and made a part of this specification.

### BACKGROUND OF THE INVENTION

1. Field of the Invention

The invention relates to a rating mechanism, and more particularly, relates to a method and an electronic device for rating outfit.

2. Description of Related Art

With the blooming development of Internet and information technology, people became accustomed to discuss, interact and share information through social networks. By using a social networks or an application, users are able to share their statuses, latest developments and current locations with friends, and upload photos to the social networks for recording life and interacting with friends.

For instance, when a user wishes to ask friends about advices regarding clothing outfit, pictures with the clothing outfit can be uploaded to the social network for the friends to vote for a rating with respect to each of the pictures, such that the user is able to understand opinions from every one according to a result of the ratings from all the friends. However, it is difficult for aforesaid rating method to receive an objective result because each person may have a different rating standard. Moreover, it may require the user to send out questions for several times yet the friends who received the questions may not always reply to the questions. In the end, such rating method only results in poor efficiency of the rating.

### SUMMARY OF THE INVENTION

Accordingly, the invention is directed to a method and an electronic device for rating outfit, which are capable of pairing each two of candidate items to create questions for raters to select and thereby improving the efficiency of the rating mechanism. Further, the raters may also be picked according to actual rating for the recommended outfits, so as to provide an outfit advice which matches more to the taste of the user.

The method for rating outfit of the invention is suitable for an electronic device. In the method, a plurality of candidate items are first received, and each two of the candidate items are paired to create a plurality of questions, where each of the questions includes two candidate items among the candidate items. Subsequently, the questions are respectively transmitted to a plurality of raters in a group, and a selection of each of the raters on the two candidate items in the received question is received. Then, a number of times that each of the candidate items is selected is aggregated, and accordingly the candidate items are sorted to form a recommending series. Thereafter, a rating for at least one of the candidate items is received, and the raters who selected the candidate item matching the rating are searched to serve as the raters for a subsequent outfit rating.

In an embodiment of the invention, the step of aggregating the number of times that each of the candidate items is selected, and accordingly sorting the candidate items to form the recommending series includes: each time when one of the candidate items is selected, accumulating one to a number of votes for the selected candidate item; and sorting the candidate items to form the recommending series according to the number of votes being accumulated.

In an embodiment of the invention, after the step of receiving the rating for the at least one of the candidate items, the method further includes: picking the candidate items having the number of times being selected greater than a threshold, editing the picked candidate items to create a magazine, and sharing the magazine to a community.

In an embodiment of the invention, the step of searching the raters who selected the candidate item matching the rating to serve as the raters for the subsequent outfit rating includes: selecting the candidate item corresponding to at least one top rating among the ratings, and searching the raters who selected the same candidate item to serve as the raters for the subsequent outfit rating.

In an embodiment of the invention, the group includes a contact group in a social network, an application or a communication software.

An electronic device of the invention includes a communication unit, a storage unit and a processing unit. Therein, the storage unit is configured to store a plurality of modules. The processing unit is coupled to the communication unit and the storage unit to access and execute the modules recorded in the storage unit. The modules include a pairing module, an inquiry module, a sorting module and an updating module. The pairing module is configured to receive a plurality of candidate items, and pair each two of the candidate items to create a plurality of questions. Each of the questions includes two candidate items among the candidate items. The inquiry module respectively transmits the questions to a plurality of raters in a group and receives a selection of each of the raters on the two candidate items in the received question through the communication module. The sorting module is configured to aggregate a number of times that each of the candidate items is selected, and accordingly sort the candidate items to form a recommending series. The updating module is configured to receive a rating for at least one of the candidate items, and search the raters who selected the candidate item matching the rating to serve as the raters for a subsequent outfit rating.

In an embodiment of the invention, each time when the candidate item is selected, the sorting module accumulates one to a number of votes for the selected candidate item, and sorts the candidate items to form the recommending series according to the number of votes being accumulated.

In an embodiment of the invention, the modules further include a sharing module, which is configured to pick the candidate items having the number of times being selected greater than a threshold, edit the picked candidate items to create a magazine, and share the magazine to a community.

In an embodiment of the invention, the updating module selects the candidate item corresponding to at least one sorted leading ratings among the ratings, and searches the raters who selected the same candidate item to serve as the raters for the subsequent outfit rating.

In an embodiment of the invention, the group includes a contact group in a social network, an application or a communication software.

Based on the above, the method and the electronic device for rating outfit provided according to embodiments of the invention are capable of pairing each two of the candidate items to create the questions for the raters to select, and aggregating the number of times that each of the candidate items is selected to obtain the recommending series. In addition, according to the embodiments of the invention, the raters may further be picked according to the actual rating for the recommended outfits, so as to update the targets for advices in the subsequence rating outfit. Accordingly, the embodiments of invention are capable of improving efficiency of the rating while providing the outfit advice which matches more to the taste of the user.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating an electronic device according to an embodiment of the invention.

FIG. 2 is a flowchart illustrating a method for rating outfit according to an embodiment of the invention.

FIG. 3A to FIG. 3C illustrate an example of the method for rating outfit according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In the invention, each two of candidate items of a user are paired to create different questions to be provided for different raters to select, and each of the raters only needs to select a desired one among the two candidate items. Accordingly, actions for rating may be simplified so as to improve the efficiency of rating. Further, in the invention, a relatively more objective recommending series may be obtained by aggregating a number of times that each of the candidate items is selected, and may be provided to the user as a basis for selecting outfit. Furthermore, in the invention, an actual rating received by the user for the recommended outfit may also be tracked, so that the raters who selected the outfit matching the actual rating are picked to serve as targets for advices in a subsequent outfit rating. By picking the raters, a rating result of the invention can be more close to the actual rating received by the user.

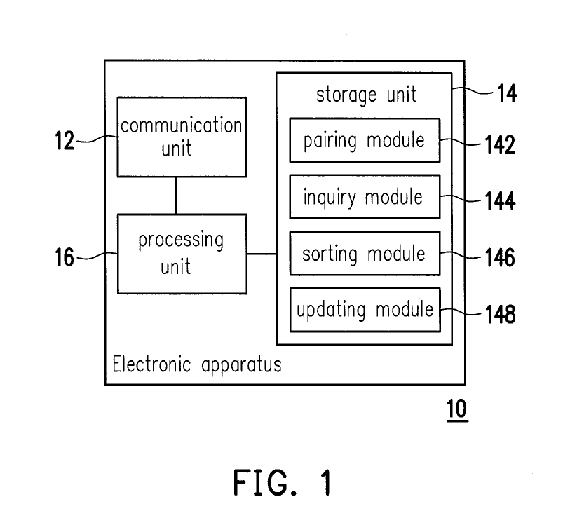

FIG. 1 is a block diagram illustrating an electronic device according to an embodiment of the invention. Referring to FIG. 1, an electronic devices 10 is, for example, a computer device with computing capability (e.g., a server, a work station or a personal computer, etc.), or a mobile device (e.g., a cell phone, a tablet computer, etc.), which are not particularly limited in the invention. The electronic device 10 includes a communication unit 12, a storage unit 14 and a processing unit 16, and their types and functions are respectively described as follows.

The communication unit 12 is, for example, a wireless communication module that supports Bluetooth, Wireless Fidelity (WiFi), Near Field Communication (NFC), 3rd Generation Partnership Project (3GPP) standards or a wireless communication module with wireless transmission capability, or a wired communication module such as Asymmetric Digital Subscriber Line (ADSL), Cable Modem and the like. In the present embodiment, the communication unit 12 is configured to respectively transmit a plurality of questions created by pairing each two of candidate items to a plurality of rater in a group, and receive the candidate item selected by each of the raters from the received question.

The storage unit 14 is, for example, a fixed or a movable device in any possible forms including a random access memory (RAM), a read-only memory (ROM), a flash memory or other similar devices, or a combination of the above-mentioned devices. In the present embodiment, the storage unit 14 is configured to record a pairing module 142, an inquiry module 144, a sorting module 146 and an updating module 148. The modules are, for example, programs stored in the storage unit 14 which can be loaded by the processing unit 16 of the electronic device 10, so that the processing unit 16 may execute the functions of rating outfit. It should be noted that, in the present embodiment, the storage unit 14 is not limited to be one single memory device. Said modules may also be stored separately in two or more of memory devices of the same or different types.

The processing unit 16 is coupled to the communication unit 12 and the storage unit 14. The processing unit 16 is, for example, a central processing unit (CPU) of single-core or multi-core or other programmable devices for general purpose or special purpose such as a microprocessor, a digital signal processor (DSP), a programmable controller, an application specific integrated circuit (ASIC) or other similar elements or a combination of above-mentioned elements. In the present embodiment, the processing unit 16 is configured to access and execute the modules recorded in the storage unit 14, so as realize a method for rating outfit according to the embodiments of the invention. In the present embodiment, the processing unit 16 is not limited to be only one single processing device, and two or more processing devices may also be used for execution together.

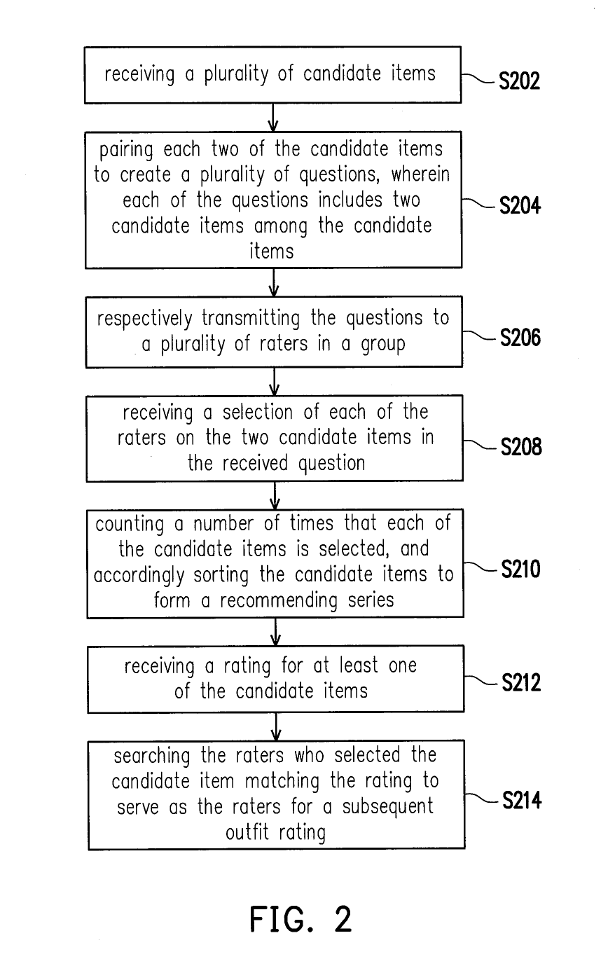

FIG. 2 is a flowchart illustrating a method for rating outfit according to an embodiment of the invention. Referring to FIG. 1 and FIG. 2 together, the method of the present embodiment is suitable for the electronic device 10 of FIG. 1. Detailed steps in the method of the present embodiment are described below with reference to each element of the electronic device 10 depicted in FIG. 1.

First of all, the pairing module 142 receives a plurality of candidate items (step S202), and pairs each two of the candidate items to create a plurality of questions, where each of the questions includes two candidate items among the candidate items (step S204). Subsequently, the inquiry module 144 respectively transmits the questions to a plurality of raters in a group (step S206), and receives a selection of each of the raters on the two candidate items in the received question (step S208). Among them, said group is, for example, a contact group of the user in a social network, an application or a communication software, or other user groups in said social network, said application or said communication software, which are not particularly limited in the invention.

The sorting module 146 aggregates a number of times that each of the candidate items is selected according to the selections of the raters received by the inquiry module 144 (step S208), and accordingly sorts the candidate items to form a recommending series (step S210). An algorithm that aggregates results of sub-questions into a result of a major question in order to form the recommending series may be known as “Pairwise Ranking Aggregation”. Specifically, in an embodiment, each time when the rater selects one of the candidate items, the sorting module 146 accumulates one to a number of votes for that candidate item. With increasing numbers of the replied raters, the number of votes accumulated by the sorting module 146 for each of the candidate items is increased gradually. Once all of the raters or a preset number of the raters have replied the questions, or after a preset time, the sorting module 146 may aggregate the number of votes for each of the candidate items, and accordingly sorts the candidate items from large to small according to the number of votes, so as to obtain the recommending series of the candidate items.

It is worth mentioning that, in addition to the number of times selected by the raters, related information such as gender or age of the rater may also be added for sorting the recommending series of the candidate items in other embodiments. Accordingly, a more useful outfit advice may be provided. On the other hand, besides the selection of the rater on the two candidate items in the received question, a comment may also be made on the candidate items in any manner. For example, the rater may mark the comment on a collar of a coat in the candidate item, or other regions in the candidate item.

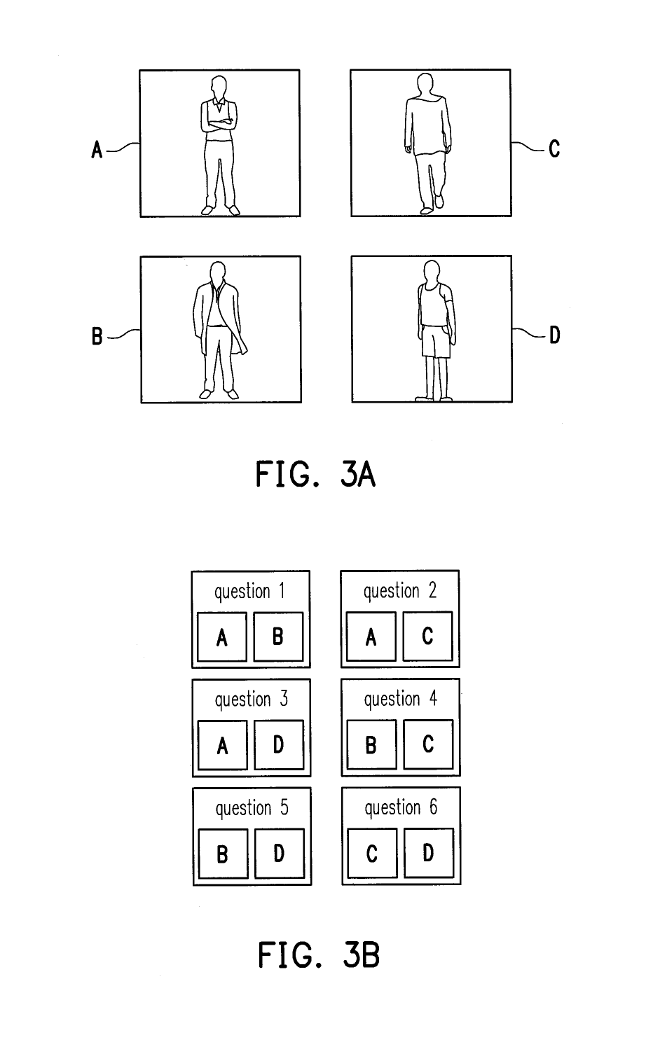

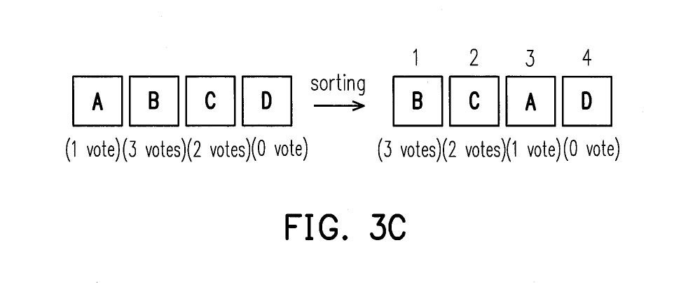

Hereinafter, further descriptions are provided with reference to examples of FIG. 3A, FIG. 3B and FIG. 3C. In this embodiment, the user uploads four candidate items A to D (the candidate items are, for example, multimedia files such as outfit pictures or videos, and the following descriptions are provided by using the four outfit pictures of FIG. 3A to serve as the candidate items A to D) to the electronic device of the invention. The electronic device pairs each two of the four candidate items A to D to create six questions (i.e., question 1 to question 6, as shown in FIG. 3B), and respectively transmits the questions to the contact group of the user on the social network for advices. The question 1 to question 6 may include a problem description “Please select one of the following two outfit pictures that you like”, so as to guide the rater to make the selection on the candidate items in the question according to the problem description. Each of contacts in the contact group may select one of the two candidate items in the received question as a preferable candidate item. Thereafter, the electronic device may collect the selection made by each of the contacts, aggregate the number of votes for each of the candidate items A to D, and accordingly sort the candidate items A to D. In the present embodiment, the numbers of votes for the candidate items A to D are 1 vote, 3 votes, 2 votes and 0 vote, respectively. Therefore, based on the number of votes (from high to low), the electronic device may obtain the recommending series of candidate items in a sequence of B, C, A, D (as shown in FIG. 3C).

By going through the process of steps S202 to S210, the user can obtain the recommending series of the candidate items to serve as a reference for selecting the outfit. Among them, by pairing each two of the candidate items to create the questions, the rater can simply make the rating in a manner of selecting one of the two. This simplified method for rating not only increases the efficiency in the rating, but also facilitates in avoiding influences from different standards for quantified ratings by different raters, such that the result of the rating can be more objective.

It should be noted that, a feedback mechanism is further provided in the invention when the user actually selects an outfit referring to the recommending series, so that the user may feedback the received actual rating for the outfit to the electronic device. Accordingly, the electronic device is capable of reducing the raters to targets having the taste that matches more to that of the user, such that the recommending series provided by the rating mechanism of the invention can gradually be closer to the actual rating for the outfit received by the user.

More specifically, referring back to the flowchart of FIG. 2, the user may upload the actual rating for the outfit received after selecting the outfit according to the candidate items to the electronic device 10. Accordingly, the updating module 148 receives a rating for at least one of the candidate items (step S212) from the user, and searches the raters who selected the candidate item matching the rating from all the raters who made selection on the candidate items to serve as the raters for a subsequent outfit rating (step S214).

Specifically, the updating module 148 selects, for example, the candidate item corresponding to at least one top rating among the received ratings, and searches the raters who selected the same candidate item to serve as the raters for the subsequent outfit rating. The top rating indicates a preferable rating received by the user after actually selecting the outfit. Therefore, it also means that the rater who made the selection matching the top rating(s) may have the taste closer to the actual rating received by the user. In other words, in the subsequent outfit rating, the outfit selected by those raters should have higher possibility for to user to receive the preferable rating. Therefore, by using said feedback mechanism, the raters who can really help the user to select the outfit may be picked so as to provide the outfit advice closer to what the user demands.

It is worth mentioning that, in addition to the recommending series of the candidate items, the electronic device 10 may also provide a sharing module (not illustrated), which is configured to share the candidate items and establish, for example, a personal outfit photo gallery. Specifically, after the number of times that each of the candidate items is selected is aggregated by the sorting module 146, the sharing module may pick the candidate items having the number of times being selected greater than a threshold (i.e., those with higher number of votes), and edit the picked candidate items to create a magazine by automatically adding elements such as templates or text thereto. The sharing module is capable of issuing said magazine regularly or irregularly, and sharing the magazine to a community. The sharing module may also include functions (e.g., push, notify, or subscribe) for allowing the user to run a personalized outfit platform and share information with the community that subscribes the magazine or receives notification regarding issue of the magazine, so as to provide diversified applications.

In summary, the method and the electronic device for rating outfit are capable of pairing each two of the candidate items to create different questions, and respectively transmitting the questions to the raters. Because the raters only need to select the preferable one candidate item, the efficiency of the rating can be improved. Further, by making the rating in the manner of selecting one of the two, different standards for quantified ratings by different raters may be avoided, such that the result of the rating can be more objective. Further, in the embodiments of the invention, the recommending series may be obtained by aggregating the number of times that each of the candidate items is selected, and then provided to the user as a reference for selecting the outfit. Moreover, the embodiments of the invention are also capable of picking the raters according to the actual rating for the outfit feedbacked from the user, such that the raters in the group may be reduced to the targets having the taste that matches more to that of the user, and the recommending series closer to the actual rating for the outfit may be provided accordingly. In addition, the candidate items selected as preferable recommendation may be edited to create the magazine to be shared to the community so as to realize the diversified applications.

Although the present invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for rating outfit, adapted for an electronic device, comprising:
receiving a plurality of candidate items;
pairing each two of the candidate items to create a plurality of questions, wherein each of the questions comprises two candidate items among the candidate items;
respectively transmitting the questions to a plurality of raters in a group;
receiving a selection of each of the raters on the two candidate items in the received question;
aggregating a number of times that each of the candidate items is selected, and accordingly sorting the candidate items to form a recommending series;
receiving a rating for at least one of the candidate items; and
searching the raters who selected the candidate item matching the rating to serve as the raters for a subsequent outfit rating.

2. The method for rating outfit according to claim 1, wherein the step of aggregating the number of times that each of the candidate items is selected, and accordingly sorting the candidate items to form the recommending series comprises:
each time when one of the candidate items is selected, accumulating one to a number of votes for the selected candidate item; and
sorting the candidate items to form the recommending series according to the number of votes being accumulated.

3. The method for rating outfit according to claim 1, wherein after the step of receiving the rating for the at least one of the candidate items, the method further comprises:
picking the candidate items having the number of times being selected greater than a threshold, and editing the picked candidate items to create a magazine; and
sharing the magazine to a community.

4. The method for rating outfit according to claim 1, wherein the step of searching the raters who selected the candidate item matching the rating to serve as the raters for the subsequent outfit rating comprises:
selecting the candidate item corresponding to at least one top rating among the ratings, and searching the raters who selected the same candidate item to serve as the raters for the subsequent outfit rating.

5. The method for rating outfit according to claim 1, wherein the group comprises a contact group in a social network, an application or a communication software.

6. An electronic device for rating outfit, comprising:
a communication unit;
a storage unit, configured to record a plurality of modules; and
a processing unit, coupled to the communication unit and the storage unit to access and execute the modules recorded in the storage unit, and the modules comprising:
a pairing module, receiving a plurality of candidate items, and pairing each two of the candidate items to create a plurality of questions, wherein each of the questions comprises two candidate items among the candidate items;
an inquiry module, respectively transmitting the questions to a plurality of raters in a group and receiving a selection of each of the raters on the two candidate items in the received question through the communication module;
a sorting module, aggregating a number of times that each of the candidate items is selected, and accordingly sorting the candidate items to form a recommending series; and
an updating module, receiving a rating for at least one of the candidate items, and searching the raters who selected the candidate item matching the rating to serve as the raters for a subsequent outfit rating.

7. The electronic device according to claim 6, wherein each time when the candidate item is selected, the sorting module accumulates one to a number of votes for the selected candidate item, and sorts the candidate items to form the recommending series according to the number of votes being accumulated.

8. The electronic device according to claim 6, wherein the modules further comprise:
a sharing module, picking the candidate items selected by the number of times greater than a threshold, editing the picked candidate items to create a magazine, and sharing the magazine to a community.

9. The electronic device according to claim 6, wherein the updating module selects the candidate item corresponding to at least one top rating among the ratings, and searches the raters who selected the same candidate item to serve as the raters for the subsequent outfit rating.

10. The electronic device according to claim 6, wherein the group comprises a contact group in a social network, an application or a communication software.
